(19) United States
(12) Patent Application Publication
(10) Pub. No.: US 2007/0051318 A1
(43) Pub. Date: Mar. 8, 2007

(54) Method and apparatus for automated feeder operation

(76) Inventors: Theodore J. Cole, Milford, IN (US); Lionel L. Kreger, Warsaw, IN (US); Charles R. Bird, Milford, IN (US); Brad Lorton, Dacula, GA (US); Bob Christenson, Syracuse, IN (US); Ken Wilson, Syracuse, IN (US); Frans Geurts van Kessel, Deurne (NL); Martin Haenen, Maasbree (NL)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 11/472,158

(22) Filed: Jun. 21, 2006

Related U.S. Application Data
(60) Provisional application No. 60/694,179, filed on Jun. 27, 2005.

(51) Int. Cl. A01K 61/02

(52) U.S. Cl. 119/57.1

(57) ABSTRACT

A system and method are provided which allows for brood gates in feeders to be completely open upon the introduction of a flock of poultry thereto in order to present a high feed level within a pan member, and then to be automatically controlled to incrementally change the size and position of the brood gate to lower the feed level within a pan member over time as the birds grow. The system includes an electronic controller which is preprogrammed to set different positions at which the brood gate should be at different times. Software within the electronic controller implements changes of the position of the brood gate at the appropriate times by sending signals to an actuator which is connected to the feeders. Movement of the actuator causes the changing of size and position of the brood gates.

### CROSS-REFERENCE AND INCORPORATION BY REFERENCE

This patent application claims the benefit of domestic priority of U.S. Provisional Application Ser. No. 60/694,179, filed Jun. 27, 2005, and entitled “Method And Apparatus For Automated Feeder Operation”. U.S. Provisional Application Ser. No. 60/694,179 is hereby incorporated by reference in its entirety.

### REFERENCE TO COMPACT DISCS (CD-R's) FILED WITH THE APPLICATION

Duplicate compact discs (CD-R's) have been filed with the present application as a computer program listing appendix. Each compact disc was created on Jun. 21, 2006 and contains the following file: “Feedwin.c” (30 kB, written May 26, 2004). The material on the compact discs is incorporated herein by reference as a computer program listing appendix.

### COPYRIGHT NOTICE

A portion of the disclosure of this patent application (including the files contained on the compact discs) contains material which is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### FIELD OF THE INVENTION

The invention relates to feeding systems designed to automatically distribute feed within feeders in an amount, and at a time, desired.

### BACKGROUND OF THE INVENTION

Feeder systems of the prior art allow for the changing of feed levels in poultry feeders in different ways. One way is to change the height of a lower feed gate (provided between a drop tube assembly and a pan member), where the larger the height, the more the amount of feed supplied to the pan member. Another way is to provide brood gates through a wall of a drop tube assembly, where when open, the brood gates provide an increased high level—or flooding—of feed in the pan member.

These systems are limited, however, because they are mostly changing the levels of feed presented in the pan members by manual operation, i.e., by the grower/producer actually manipulating the feeders to change a height of the lower feed gate or by actual manipulation to open/close the brood gates. Such a system is disadvantageous because it takes significant time/labor for a grower/producer to manually change same and the changing of same can potentially cause injury to the grower/producer as his/her hand must generally be inserted into the confines of the feeder to make the change.

In these systems, the brood gates may also be opened/closed by the raising or lowering of the entire feed line, typically off of, or onto, the floor of a poultry house. The problem with these types of systems, however, is that uniformity of the position of the brood gate cannot be ensured as the position of the brood gate will depend upon the position of the feeder relative to a floor of the poultry house, as well as a position of the feed line relative to a floor of the poultry house. Thus, feeders along a feed line in such a system could have brood gates which are in different positions, such that more feed is being supplied to one feeder than to another. This can cause various problems in feeding within the poultry house.

Also, these systems tend to allow for only fully opened or fully closed brood gates as they are not designed to have partially opened/partially closed positions. These systems are thus limited in how feed can be presented to the poultry in a poultry house.

### SUMMARY OF THE INVENTION

A system and method are provided which allows for brood gates in feeders to be completely open upon the introduction of a flock of poultry thereto in order to present a high feed level within a pan member, and then to be automatically controlled to incrementally change the size and position of the brood gate to lower the feed level within a pan member over time as the birds grow. The system includes an electronic controller which is preprogrammed to set different positions at which the brood gate should be at different times. Software within the electronic controller implements changes of the position of the brood gate at the appropriate times by sending signals to an device which is connected to the feeders. Movement of the actuator causes the changing of size and position of the brood gates.

### BRIEF DESCRIPTION OF THE DRAWINGS

The organization and manner of the structure and operation of the invention, together with further objects and advantages thereof, may best be understood by reference to the following description, taken in connection with the accompanying drawings, in which:

FIG. 1 illustrates a diagram of the connection of the system/apparatus of the invention with the feeders;

FIG. 2 illustrates a side elevational view of an actuator and a feeder being secured to a feed line, and the actuator and the feeder being connected to one another by a wire;

FIG. 3 illustrates a top view of a feed distribution system having the actuator and feeders secured to a feed line;

FIG. 4 is a perspective view of the feeder and the wire being secured thereto;

FIG. 5 is a partial cross-sectional view of the feeder where the brood gate is in a fully opened position where the highest feed level is provided within a pan member;

FIG. 6 is a side view of the brood gate being in the fully opened position of FIG. 5;

FIG. 7 is a partial cross-sectional view of the feeder where the brood gate is in a partially opened/partially closed position where a reduced feed level is provided within the pan member;

FIG. 8 is a side view of the brood gate being in the partially opened/partially closed position of FIG. 7;

FIG. 9 is a partial cross-sectional view of the feeder where the brood gate is closed such that a minimum feed level is provided within the pan member through a lower feed gate;

FIG. 10 is a side view illustrating the brood gate being closed from FIG. 9; and

FIG. 11 is a flow chart illustrating the steps taken by the software to change the position of the brood gate over time.

### DETAILED DESCRIPTION OF THE ILLUSTRATED EMBODIMENT

While this invention may be susceptible to embodiment in different forms, there is shown in the drawings and will be described herein in detail, a specific embodiment with the understanding that the present disclosure is to be considered an exemplification of the principles of the invention, and is not intended to limit the invention to that as illustrated.

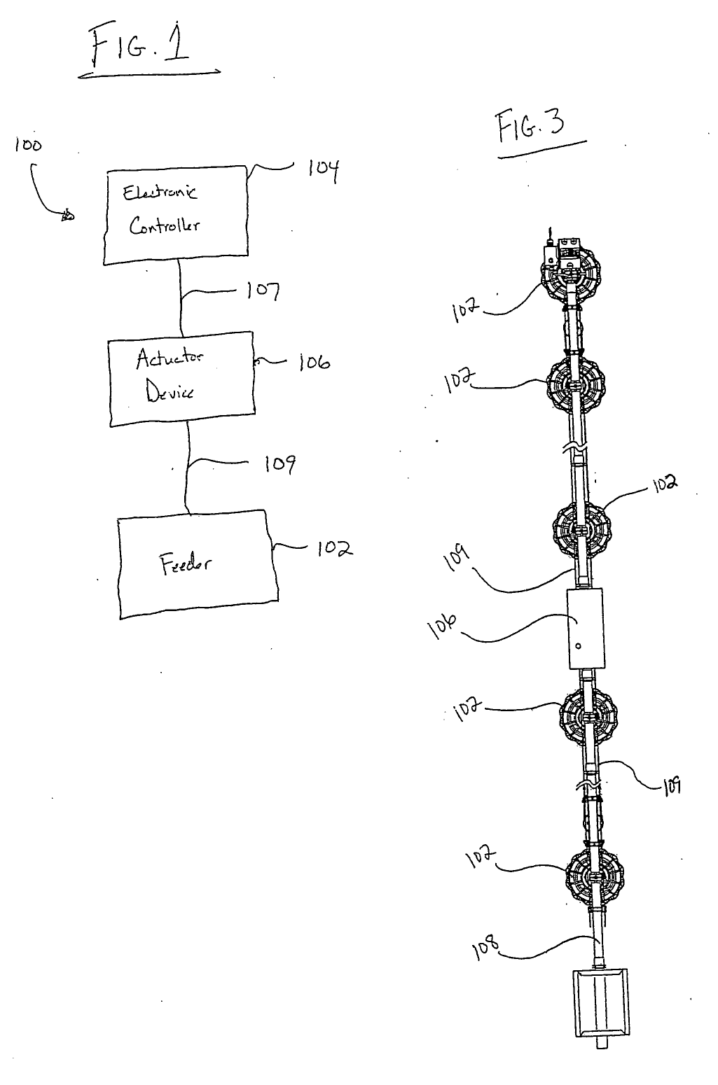

The invention provides a system/apparatus 100 and a method of use thereof, for automatically controlling the operation of a feeder 102. The system/apparatus 100 and the feeder 102 are generally illustrated in FIG. 1.

As illustrated in FIG. 1, the system/apparatus 100 generally includes an electronic controller 104 and an actuator device 106. The electronic controller 104 is configured such that it can have software implemented therein, or can be controlled by, for instance, a computer (not shown) which has software implemented therein. The electronic controller 104 is operatively associated with the actuator device 106 by known means, preferably wiring 107, such that signals can be sent from the electronic controller 104 to the actuator device 106. One example of the electronic controller 104 is the CHORE-TRONICS® Controls sold by Chore-Time Poultry Production Systems, a division of CTB, Inc. Of course, it is to be understood that all other suitable means of transferring signals from one device to another could be utilized, such as by radio transmission, infra red transmission or RF transmission.

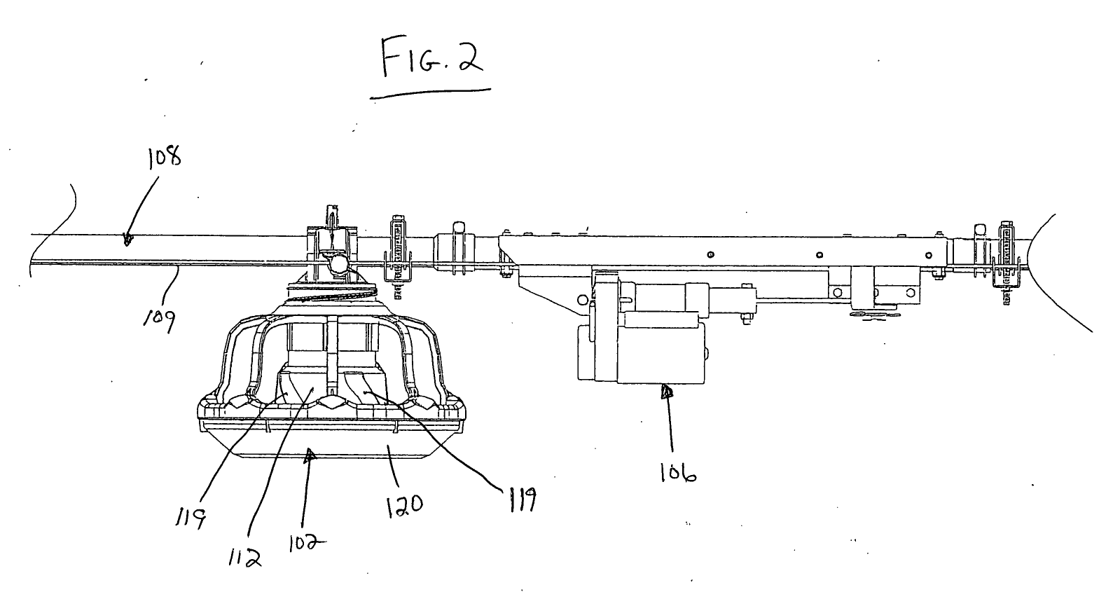

The actuator device 106 is preferably a linear actuator which contains both electronic and mechanical components therein. However, any type of mechanical or electromechanical device will suffice. The electrical components of the actuator device 106 are configured to receive the signals from the electronic controller 104. The electronics components of the actuator device 106 are operatively associated with the mechanical components in order to cause the mechanical components to perform predetermined movements/activities based on the signals received by the electrical components of the actuator device 106. A preferred embodiment of the actuator device 106 is illustrated in FIG. 2, and as illustrated, is preferably mounted to a feed delivery pipe 108 of a feed conveying system, of which the feeder 102 is a part thereof.

The mechanical components of the actuator device 106 are operatively associated with one or more of the feeders 102. In a preferred embodiment, the mechanical components of the actuator device 106 are attached to the feeders 102 by one or more wires 109, as illustrated in FIG. 3, which are high tensile wires, such that movement of the mechanical components of the actuator device 106 causes movement of the wire 109. However, any type of cable, wire, rod, or the like could also be used.

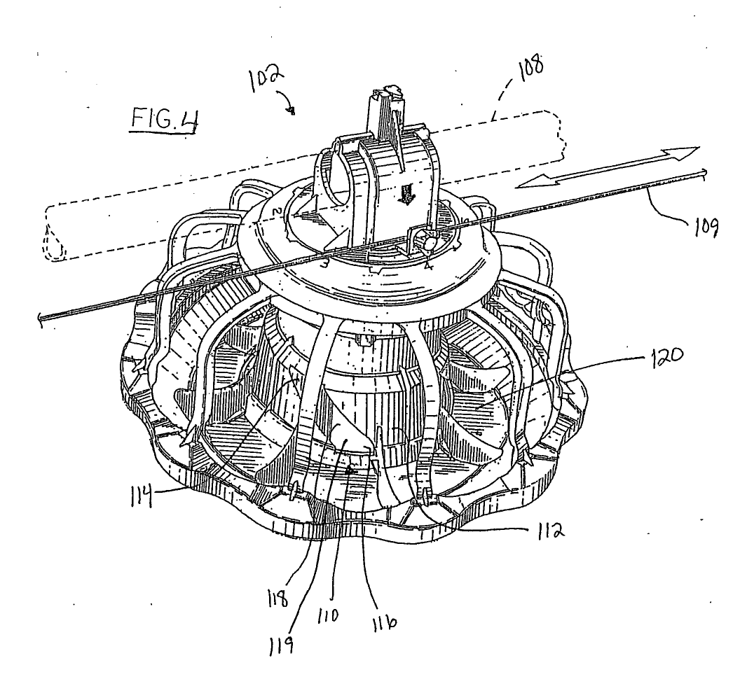

The feeders 102, which are best illustrated in FIGS. 4-10, are of the general type which are configured to receive feed from a feed supply source such that the feed can be presented to agricultural animals in a pan member 120 of the feeder 102. In a preferred embodiment, the feeders 102 are preferably poultry feeders which are configured to have a brood gate 119 which is provided through a side of a drop tube assembly 110 of the feeder 102. The brood gate 119 is of a type which can be opened, closed or partially opened/partially closed in a variety of positions such that feed supplied to the feeder 102 can either flow or be prevented from flowing through the brood gate 119.

The wire 109 is thus operatively associated with the feeder 102 in such a manner that upon movement of the wire 109, the feeder 102 is caused to vary the position of the brood gates 119 between open, closed and a predetermined number of partially open/partially closed positions. As such, the amount of feed flowing through the brood gate 119 in the feeder 102 can be automatically controlled. Signals received by the electronics components of the actuator device 106 from the electronics controller 104 cause the mechanical components of the actuator device 106 to move the wire 109.

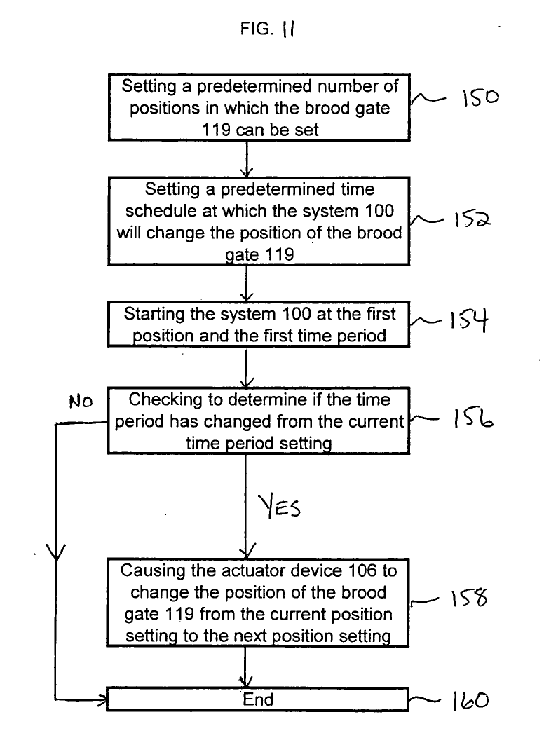

An example of a feeder 102 in which the above-identified system/apparatus 100 is preferably utilized is of the type disclosed in U.S. Pat. No. 7,040,250, which is commonly owned by the assignee of the present application, and which the disclosure provided therein is incorporated herein by reference. The feeder 102 disclosed in U.S. Pat. No. 7,040,250 is illustrated in FIGS. 2-10. As such, the feeders 102 are provided with a drop tube assembly 110 having a first stationary drop tube member 112 and a second rotatable drop tube member 114. Each of the drop tube members 112, 114 have windows 116, 118, respectively provided therethrough, which form a brood gate 119. The second rotatable drop tube member 114 may be rotated relative to the first stationary drop tube member 112 in order to: (1) misalign the windows 116, 118 such that no feed can flow through the windows 116, 118 (see FIGS. 9 and 10) where feed is prevented from flowing through the brood gate 119, but is allowed to flow through a lower feed gate 121); and (2) align predetermined, different portions of the window 118 with predetermined, different portions of the window 116 such that the brood gate 119 can be varied between predetermined positions and/or sizes, such that the amount of feed which is allowed to flow through the brood gate 119 to be presented in the pan member 120, and thus the level of the feed in the pan member 120, can be varied as desired.

As such, as illustrated in FIG. 3, the wire 109 can be operatively associated with the second rotatable drop tube member 114 such that movement of the wire 109 causes the second rotatable drop tube member 114 to rotate relative to the first stationary drop tube member 112, thus allowing for a grower to automatically control the amount of feed which is allowed to flow through the brood gate 119 to be presented in the pan member 120, if any.

It should be noted that in U.S. Pat. No. 7,040,250, the first stationary drop tube member 112 is described and illustrated as an outer drop tube member and the second rotatable drop tube member 114 is described and illustrated as an inner drop tube member. While this is the current embodiment of the feeder 102 in which the invention is utilized, it is to be understood that the invention would work in exactly the same manner even if the first stationary drop tube member 112 were the inner drop tube member and the second rotatable drop tube member 114 were the outer drop tube member. Both scenarios are intended to be within the scope of the present invention.

A representative copy of the software/code which has been implemented into the controller 104 to control the actuator device 106 is provided for on the compact discs which have been filed with the present application and incorporated herein by reference. This software is a preferred embodiment, but obviously other software/code could be provided which causes similar automatic control. Specifically, this software operates on a ramped program with a number of steps or stages of change that can be utilized by the grower. Each step is set for a designated period of time of movement of the second rotatable drop tube member 114 relative to the first stationary drop tube member 112, where each designated period of time of movement causes the second rotatable drop tube member 114 to move a predetermined distance, thus effectively continuously changing the size and position of the brood gate 119 such that the amount of feed presented in the pan member 120 through the brood gate 119 is effectively varied as desired.

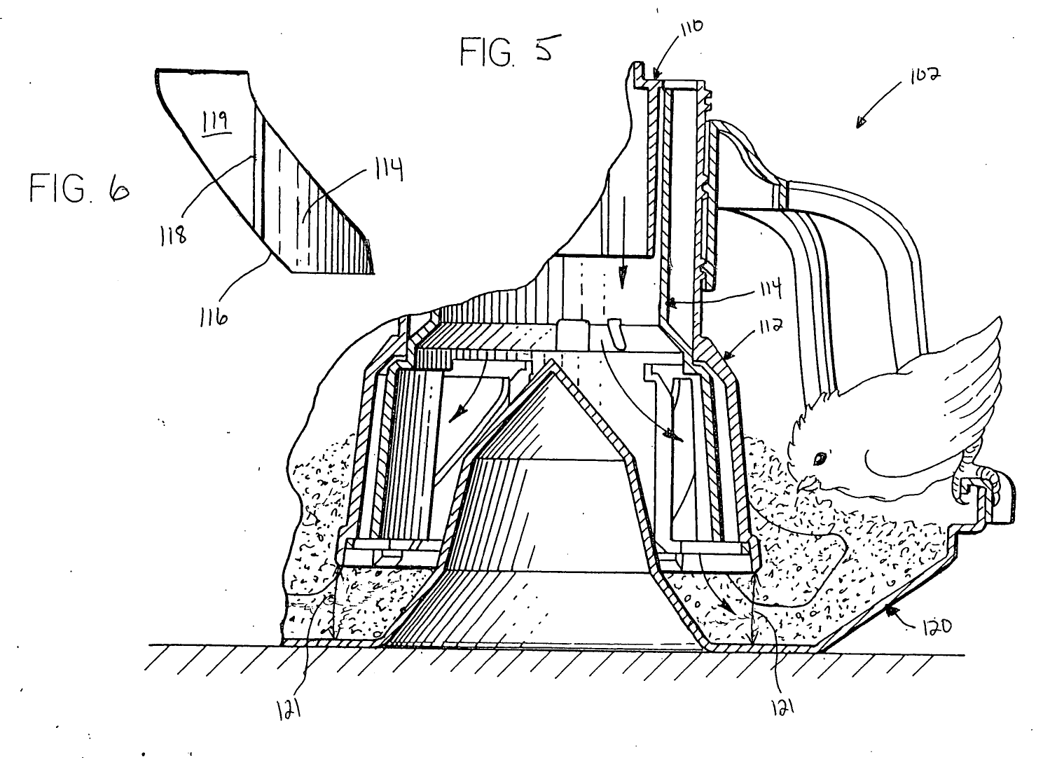

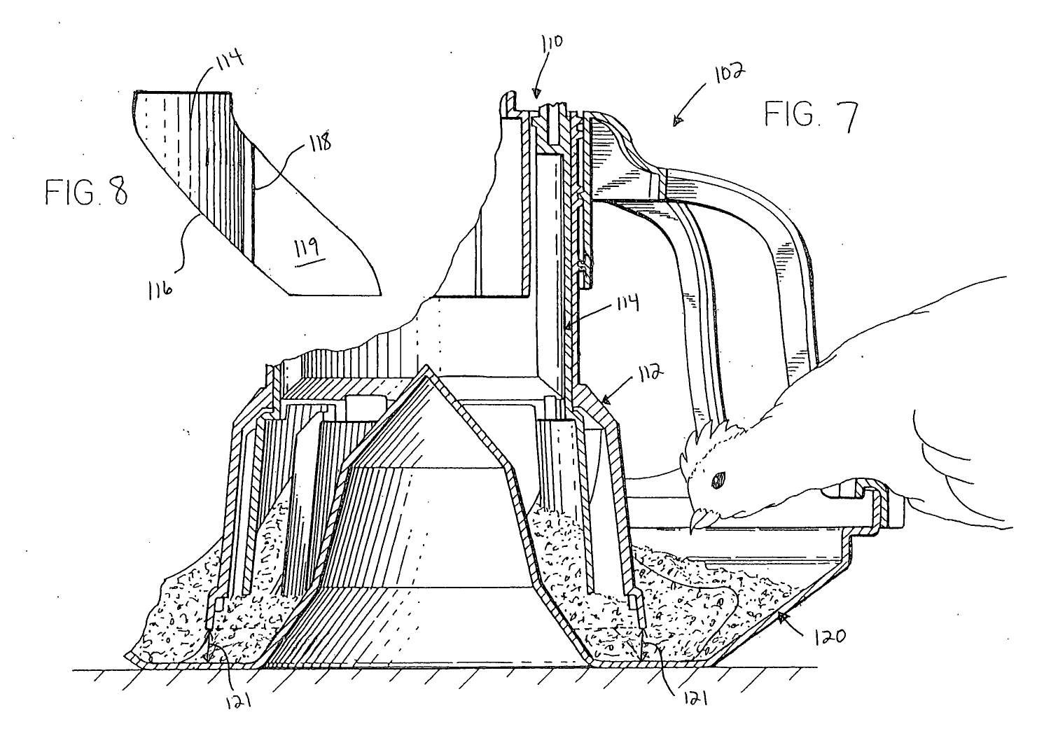

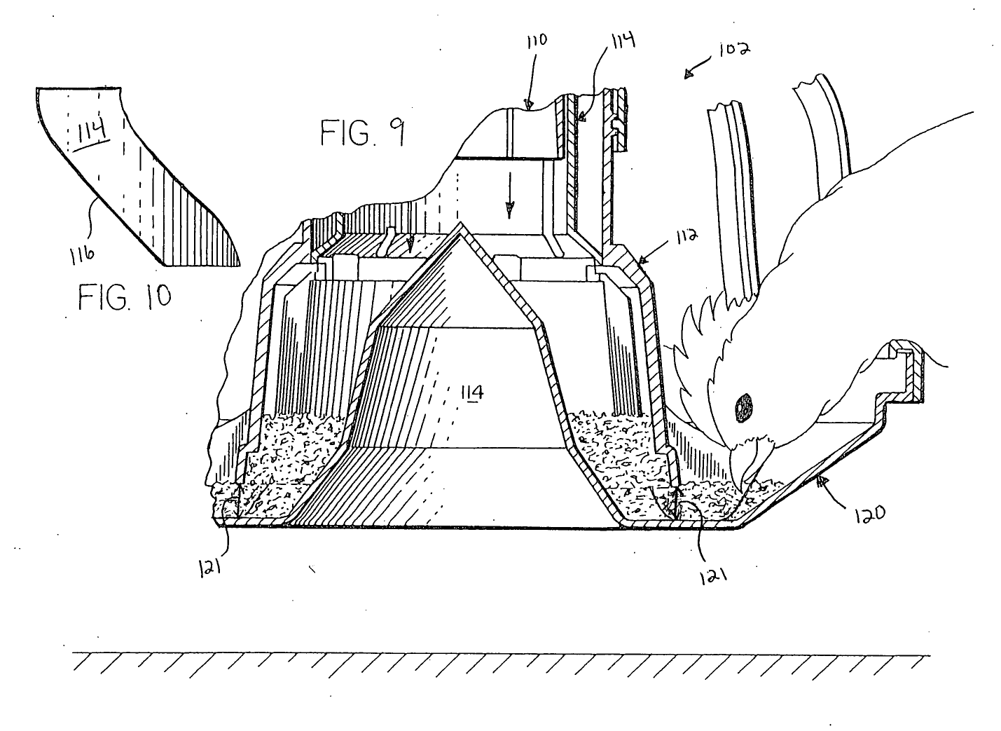

The software generally works by following the steps identified in the flow chart of FIG. 11. Step 150 sets a predetermined number of positions in which the brood gate 119 can be set. For example, ten (10) separate positions of the brood gate 119 can be predetermined where a first position of the brood gate 119, as illustrated in FIGS. 5 and 6, is the completely open position of the brood gate 119 at which the highest level of feed, and thus the largest amount of feed, is presented in the pan member 120 (used for poultry at a very early age), a tenth position of the brood gate 119, as illustrated in FIGS. 9 and 10, is the completely closed position of the brood gate 119 (where windows 116, 118 do not match up), at which no feed is allowed to flow through the brood gate 119, but rather must all flow through the lower feed gate 121 (used for poultry at its older age), and second through ninth positions of the brood gate 119, of which FIGS. 7 and 8 illustrate one of these positions, where the windows 116, 118 match up, such that feed is allowed to flow through the brood gate 119, but at which the level of feed, and the amount of feed provided therethrough, is less than that at the first position.

Step 152 sets a predetermined time schedule at which the system 100 will change the position of the brood gate 119, for example from the first position to the second position, or the seventh position to the eighth position. These time periods are generally provided for in intervals of days. For example, the first position of the brood gate 119 may be set for days 1-9, the second position of the brood gate 119 may be set for days 10-14, etc.

Step 154 starts the system 100 at the first position and the first time period.

Step 156 checks to determine if the time period has changed from the current time period setting.

If the time period setting was previously days 1-9, and it is determined that the time still falls within this time period, for example, it is day 8, step 160 is implemented and the software completes its cycle.

If, however, the time period setting was previously days 1-9, and it is determined that the time falls outside of this time period, for example, it is day 10, step 158 is implemented and the software causes the actuator device 106 to change the position of the brood gate 119 from the first position to the second position, and then step 160 is implemented such that the software then completes its cycle.

After a predetermined period of time after the completion of the cycle, for instance 500 milliseconds, the software returns to step 156 and continues from thereon.

In actual operation, at the beginning of a flock of poultry when the birds are very young and small, the brood gates 119 are completely open (FIGS. 5 and 6) in order to present a high feed level within the pan member 120. The system/apparatus 100 is used to automatically control the brood gates 119 and to keep them completely open. As time passes and the birds grow, the system/apparatus 100 automatically controls the feeder 102 to rotate the second rotatable drop tube member 114 in small increments at designated times (predetermined by the implemented software) in order to lower the height of the brood gate 119 (FIGS. 7 and 8 for example), in order to reduce the high feed level presented in the pan member 120, yet still provide ample feed volume. This is important because it is known that during the first seven (7) to ten (10) days the bird weight and uniformity achieved continues through to the end of the flock grow/growout period. The design of the feeder 102, in conjunction with the system/apparatus 100, allows a brooding feed level to continue for a predetermined number of days, preferably twenty (20), whether the pan members 120 are on the floor or slightly raised.

By being able to extend the length of the brooding process, it promotes rate of gain and uniformity that will continue through to market. It has been proven that the combination of this system/apparatus 100 with the feeder 102 provides the ability to reach target weights 0.5 to 1.0 days sooner than with previous feeders. Thus, more uniform flocks are achieved during the designated grow period.

The software is provided with a default setting to set the automatic actuation to factory recommendations, but can also be programmed to a desired program of steps/stages by the grower/producer. Thus, one advantage of the system/apparatus 100 is that the brood gates 119 automatically get moved at specified intervals and saves the producer from tracking and taking the time to manually change the brood gate 119 settings. Although the settings of the system 100 can be manually overridden, if desired.

Thus, this system/apparatus 100 provides many benefits to the grower as it takes the place of having to manually adjust the feeder 102 in order to control the amount of feed which is presented. Another advantage is that the system/apparatus 100 ensures that all of the feeders 102 within a poultry house are all set to have the brood gate 119 at the same position at the same time, with no real variation between the positions. This can be achieved without the grower manually adjusting the feeders 102, which takes time and can possibly cause injury, and without the need to raise and lower the feed line 108. The raising and lowering of the feed line 108 cannot ensure uniformity of the position of a brood gate 119 as variations in the poultry house could affect this, such as variations in the level of the floor of the poultry house.

It should be noted that the software may include further steps than those illustrated in FIG. 11. For instance, the software may include steps to determine whether recalibration of the system/apparatus 100 and the feeders 102 is necessary. If recalibration is necessary, the software will act to implement recalibration. If recalibration is not necessary, the software will cause open close relay control to be implemented. Typically, recalibration is only necessary after the system/apparatus 100 is changed from manual operation (the system/apparatus 100 can be deactivated to allow the grower/producer to manually change a size and a position of the brood gates 119, if desired) to automatic operation as discussed hereinabove, or by a changing of the total travel time (a predetermined travel time is set, generally between 8 and 99 seconds, for the brood gate 119 to be changed from the fully opened position to the fully closed position). Recalibration must be done manually after a power outage.

It should also be noted that the position of the brood gate 119 can be changed as desired independently of the changing of a size of a lower feed gate 121, such that a grower/producer can further change the level of feed presented within the feeders 102 by changing the size of the lower feed gate 121.

While a preferred embodiment of the present invention is shown and described, it is envisioned that those skilled in the art may devise various modifications of the present invention without departing from the spirit and scope of the appended claims.

The invention is claimed as follows:

1. An apparatus configured to automatically operate a feeder having a feed gate, said apparatus comprising:
an electronic controller; and
an actuator which is operatively associated with, and controlled by, said electronic controller, said actuator further being operatively associated with the feeder;
wherein said electronic controller is configured to automatically control said actuator in order to cause said actuator to vary a position of the feed gate of the feeder.

2. An apparatus as defined in claim 1, wherein said electronic controller is configured to automatically control said actuator in order to cause said actuator to vary between a plurality of predetermined positions of the feed gate of the feeder.

3. An apparatus as defined in claim 2, wherein said electronic controller is configured to automatically control said actuator in order to cause said actuator to vary between a plurality of predetermined positions of the feed gate of the feeder at a plurality of predetermined time periods.

4. An apparatus as defined in claim 1, wherein said feed gate is a brood gate provided through a wall of a drop tube assembly of the feeder.

5. An apparatus as defined in claim 1, wherein said actuator is a linear actuator having both electrical and mechanical components.

6. An apparatus as defined in claim 1, wherein said actuator is configured to receive signals from said electronic controller in order to cause said actuator to vary a position of the feed gate of the feeder.

7. An apparatus as defined in claim 1, wherein said actuator is operatively associated with the feeder by a wire.

8. An apparatus as defined in claim 1, wherein said electronic controller operates in accordance with, and includes, computer software.

9. A feed distribution system comprising:
a feed line;
a plurality of feeders, each said feeder having a drop tube assembly and a pan member, said drop tube assembly having a brood gate defined through a wall thereof, said drop tube assembly configured to be manipulated to change a position of said brood gate, each said feeder being operatively associated with said feed line for receiving feed from said feed line such that the feed can flow through said drop tube assembly, through said brood gate and into said pan member for presentation thereof; and
a system for controlling said position of said brood gate including an electronic controller, an actuator and a member for connecting said actuator to said drop tube assembly, said actuator being operatively associated with, and controlled by, said electronic controller, said actuator further being operatively associated with said drop tube assembly, wherein said electronic controller is configured to automatically control said actuator in order to cause said actuator to vary a position of said brood gate.

10. A feed distribution system as defined in claim 9, wherein said actuator is secured to said feed line.

11. A feed distribution system as defined in claim 9, wherein said actuator is a linear actuator having both electrical and mechanical components, said electrical components of said linear actuator configured to cause said mechanical components of said linear actuator to manipulate said drop tube assembly in order to change a position of said brood gate.

12. A feed distribution system as defined in claim 11, wherein said actuator is operatively associated with said drop tube assembly by a wire, said mechanical components of said linear actuator moving said wire in order to manipulate said drop tube assembly in order to change the position of said brood gate.

13. A feed distribution system as defined in claim 9, wherein said drop tube assembly includes a first stationary drop tube member and a second movable drop tube member, each said drop tube member having a window defined through a wall thereof, said actuator operatively associated with said second movable drop tube member in order to vary the position of said window of said second movable drop tube member relative to said window of said first stationary drop tube member in order to vary a position of said brood gate.

14. A feed distribution system as defined in claim 13, wherein said second movable drop tube member is rotatable relative to said first stationary drop tube member.

15. A feed distribution system as defined in claim 9, wherein said electronic controller is configured to automatically control said actuator in order to cause said actuator to vary between a plurality of predetermined positions of said brood gate.

16. A feed distribution system as defined in claim 15, wherein said electronic controller is configured to automatically control said actuator in order to cause said actuator to vary between a plurality of predetermined positions of said brood gate at a plurality of predetermined time periods.

17. A feed distribution system as defined in claim 9, wherein said actuator is configured to receive signals from said electronic controller in order to cause said actuator to vary a position of said brood gate.

18. A feed distribution system as defined in claim 9, wherein said electronic controller operates in accordance with, and includes, computer software.

19. A method of automatically operating a feeder having a feed gate, said method comprising the steps of:
(a) providing the feeder having a feed gate;
(b) providing an electronic controller;
(c) providing an actuator which is operatively associated with, and controlled by, said electronic controller, said actuator further being operatively associated with the feeder;
(d) sending a signal from said electronic controller to said actuator in order to cause said actuator to vary a position of the feed gate of the feeder.

20. A method as defined in claim 19, wherein said feed gate is a brood gate provided through a wall of a drop tube assembly of the feeder.

21. A method as defined in claim 19, wherein said electronic controller operates in accordance with, and includes, computer software.

22. A method of automatically operating a feeder having a feed gate, said method comprising the steps of:
(a) providing a feeder having a drop tube assembly defining a brood gate through a wall of said drop tube assembly;
(b) providing a system having an electronic controller and an actuator, said actuator being operatively associated with, and controlled by, said electronic controller, said actuator further being operatively associated with said drop tube assembly;
(c) setting said electronic controller with a predetermined number of positions in which said brood gate can be set;
(d) setting said electronic controller with a predetermined time schedule at which said system will change the position of said brood gate;
(e) starting said system at one of said predetermined number of positions;
(f) determining whether a new position of said brood gate is allowed based on said predetermined time schedule; and
(g) if a new position of said brood gate is allowed, sending a signal from said electronic controller to said actuator to cause a change in the position of said brood gate from one predetermined position to another.

23. A method as defined in claim 22, wherein said electronic controller operates in accordance with and includes computer software.
